(19) United States
(12) Patent Application Publication
(10) Pub. No.: US 2022/0283811 A1
(43) Pub. Date: Sep. 8, 2022

(54) LOOP BUFFERING EMPLOYING LOOP CHARACTERISTIC PREDICTION IN A PROCESSOR FOR OPTIMIZING LOOP BUFFER PERFORMANCE

(71) Applicant: Microsoft Technology Licensing, LLC, Redmond, WA (US)

(72) Inventors: Rami Mohammad AL SHEIKH, Morrisville, NC (US); Daren E. STREETT, Cary, NC (US); Michael Scott MCILVAINE, Raleigh, NC (US); Saransh JAIN, Raleigh, NC (US); Richard W. DOING, Raleigh, NC (US); Robert Douglas CLANCY, Cary, NC (US)

(21) Appl. No.: 17/191,252

(22) Filed: Mar. 3, 2021

(51) Int. Cl. G06F 9/30; G06N 5/04; G06F 9/38

(52) U.S. Cl. CPC G06F 9/30065; G06N 5/04; G06F 9/30058; G06F 9/3867

(57) ABSTRACT

Methods and apparatus for providing loop buffering employing loop iteration and exit branch prediction in a processor for optimizing loop buffer performance are disclosed herein. A loop buffer circuit in the processor can be configured to predict the number of iterations that a detected loop in an instruction stream will be executed before the loop is exited is predicted, to reduce or avoid under- or over-iterating loop replay. The loop buffer circuit can also be configured to predict the loop exit branch of the detected loop to predict the exact number of full iterations of the loop to be replayed and what instructions to replay for the last partial iteration of the loop, to further reduce or avoid under- or over-iterating loop replay. The loop buffer circuit can also be configured to predict the exit target address of the loop to provide the starting address for fetching new instructions following loop exit for resuming fetching of new instructions following the loop exit.

### FIELD OF THE DISCLOSURE

The technology of the disclosure relates generally to performing loop buffering (i.e., loop detection and replay) for loops in computer software instructions processed in a processor.

### BACKGROUND

Microprocessors, also known as “processors,” perform computational tasks for a wide variety of applications. A conventional microprocessor includes a central processing unit (CPU) that includes one or more processor cores, also known as “CPU cores,” that execute software instructions. The software instructions instruct a CPU to perform operations based on data. The CPU performs an operation according to the instructions to generate a result, which is a produced value. Processors employ instruction pipelining as a processing technique whereby the throughput of instructions being executed by a processor may be increased by splitting the handling of each instruction into a series of steps. These steps are executed in one or more instruction pipelines each composed of multiple stages in an instruction processing circuit. In this regard, an instruction processing circuit in a processor includes an instruction fetch circuit that is configured to fetch instructions to be executed from an instruction memory (e.g., system memory or an instruction cache memory). The fetched instructions are decoded in a decoding state and inserted into an instruction pipeline to be pre-processed before reaching an execution circuit to be executed.

Many modern high-performance processors deploy a loop buffer for further pipeline optimization and power savings. A loop is defined as any sequence of instructions in the pipeline whose processing is repeated sequentially in back-to-back operations. For example, loops can occur based on programming software loop constructs that are then compiled in instructions that, according to their processing, will cause a loop operation. FIG. 1 illustrates an example of an instruction stream 100 of instructions that includes an example loop 102. The loop 102 is a “while” loop that begins with a while instruction 104 that has a condition that is evaluated when processed. Instructions 106-112 in the loop 102 are executed and continue to be executed in a loop if the condition of the while instruction 104 is evaluated as true. The loop 102 is exited from the while instruction 104 as an exit branch instruction, to a next instruction 114 at an exit target address, in response to the condition of the while instruction 104 being evaluated as false. If a loop, such as the loop 102 in FIG. 1, can be detected in a pipeline, the instructions in the loop can be captured and replayed for the number of iterations the loop is processed before exiting without having to re-fetch and re-decode such instructions. This is because the loop involves the same sequence of instructions that will have already been fetched and decoded for the first iteration of the loop. In this manner, the fetch and decode stages of the pipeline can be de-activated or otherwise stalled to conserve power in the pipeline if a loop can be detected and replayed. In this regard, many processors include a loop buffer in its instruction pipeline that includes a loop detection circuit and a loop replay circuit. The loop detection circuit is configured to identify a repeated sequence of instructions in an instruction stream processed in an instruction pipeline to detect a loop. In response to detection of a loop, the loop replay circuit is configured to capture the sequence of instructions in the detected loop and replay such instructions in the instruction pipeline for the defined number of loop iterations (called “trip count”) or indefinitely, depending on design, without such instructions having to be re-fetched and re-decoded. The fetch and decoding stages of the instruction pipeline can be restarted once the loop is exited to then start fetching and decoding instructions starting from the end of the detected loop. Using a fixed trip (i.e., iteration) count could cause the loop to be replayed more times than needed thus decreasing performance This is because the instructions following the loop exit may be delayed from being fetched and processed in the pipeline in a timely manner after the proper number of iterations of the loop. Using a fixed trip count could also cause the loop to be replayed less times than needed thus causing additional re-fetches and re-decodes that consume additional power.

A conventional loop buffer in a processor may also be designed to ignore or not otherwise identify short loops (i.e., loops with a small number of instructions) and/or loops with multiple exit points. This is because the power savings benefit of identifying and replaying such loops may be outweighed by the power cost and complexity associated with identifying and replaying such loop. For example, the processor may wait until a pre-defined number of iterations of a loop are detected before the loop is considered detected for replay. Further, it may be difficult to track or otherwise predict the number of iterations that a loop will iterate for loops that contain multiple exit points. Loop buffering of small loops and/or loops with multiple exit points could actually reduce processor performance and increase power consumption.

### SUMMARY

Exemplary aspects disclosed herein include loop buffering employing loop characteristic prediction in a processor for optimizing loop buffer performance The processor includes an instruction processing circuit configured to fetch computer program instructions (“instructions”) into an instruction stream in an instruction pipeline(s) to be processed and executed. Loops can be contained in the instruction stream. A loop is a sequence of instructions in the instruction stream that repeat sequentially in a back-to-back arrangement. The instruction processing circuit includes a loop buffer circuit that is configured to detect loops. In response to a detected loop, the loop buffer circuit is configured to capture (i.e., loop buffer) instructions in the detected loop and insert (i.e., replay) the captured loop instructions in the instruction pipeline for iterations of the loop. In this manner, the instructions in the loop do not have to be re-fetched and re-processed, for example, for the subsequent iterations of the loop. Thus, loop buffering can conserve power by not having to re-fetch and re-process instructions in the loop for subsequent iterations of the loop. In exemplary aspects, the loop buffer circuit is configured to predict the number of iterations that a detected loop in the instruction stream will be executed before the loop is exited, as a loop iteration prediction. The loop iteration prediction is a type of loop characteristic prediction. This is to reduce or avoid under- or over-iterating the loop replay. The loop iteration prediction is used to control the number of iterative replays of the loop in the instruction pipeline. For example, a design that chooses a fixed iteration assumption for controlling replay may more often under- or over-iterate loop replay. As another example, a design that chooses to indefinitely replay a loop until a detected exit will over-iterate loop replay. Under-iterating a loop replay results in instructions in the loop being re-fetched and re-processed in the instruction pipeline that otherwise could have been replayed, thus consuming additional power unnecessarily. Over-iterating a loop replay results in additional replay of iterations of the loop in the instruction pipeline that reduces processor performance by such additional iterations being processed unnecessarily.

A replayed loop in the instruction pipeline of the processor may exit without a full iteration. In other words, the last iteration of a loop may be a partial iteration where the loop is exited before all instructions in the loop are fully replayed. In this regard, in other exemplary aspects, the loop buffer circuit can also be configured to predict the loop exit branch of the detected loop as a loop exit branch prediction. The loop exit branch prediction is a type of loop characteristic prediction. The prediction can be used to assist the loop buffer circuit in predicting the exact number of full iterations of the loop to replayed and what instructions to replay for the last partial iteration of the loop. Predicting the number of loop iterations and the loop exit branch allows a more accurate prediction of the number of full iterations of the loop to be replayed in the instruction pipeline to further reduce or avoid under- or over-iterating of the loop replay. Providing a more accurate prediction of the loop iterations to be replayed before the loop is exited can reduce the overhead penalty that would be associated with inaccurately predicting loop iteration for replay of shorter-length, detected loops. Providing a more accurate prediction of the loop iterations to be replayed before the loop is exited can also allow the loop buffer circuit to more accurately instruct the instruction fetch circuit when to resume the fetching and processing of new instructions following a detected loop. This can reduce or avoid instruction bubbles in the instruction pipeline. In this regard, the loop buffer circuit can be configured to instruct the instruction fetch circuit to resume fetching of new instructions following the loop exit based on the predicted loop exit branch of the loop.

The loop buffer circuit can be configured to instruct the instruction fetch circuit to halt fetching and processing of new instructions while a detected loop is being replayed to conserve power. However, the replayed loop may have multiple exit points that could be taken during the last partial iteration of the replayed loop. The next address from which to fetch instructions following a loop exit is not necessarily the next sequential instruction after the loop. In this regard, in other exemplary aspects, the loop buffer circuit can also be configured to predict the exit target address of the loop as a loop exit target prediction. The loop exit target prediction is a type of loop characteristic prediction. The loop buffer circuit can use the exit target address of the loop exit target prediction to instruct the instruction processing circuit as to the starting address to fetch new instructions following the loop exit when instruction fetching is resumed. The loop buffer circuit could be configured to instruct the immediate resumption of instruction fetching during loop replay without having to wait until the loop is exited in replay. Otherwise, if instruction fetching is resumed before the loop is exited, it may be more likely that the instruction pipeline will have to be flushed if instruction fetching is resumed before loop exit due to fetching of instructions that do not follow the correct next address following the loop exit. The loop buffer circuit can also be configured to instruct resumption of instruction fetching following a detected loop based on a defined period of time before the loop is exited based on the predicted number of loop iterations and the loop exit branch as a further optimization. Predicting the loop exit target of a replayed loop may make it more feasible for a loop buffer design to detect and replay shorter loops (as opposed to only replaying longer loops). This is because the instruction fetch circuit can more accurately restart the fetching of next instructions that follow the actual exit of the replayed loop based on the exit target prediction. In the absence of a loop exit target prediction, the cost associated with restarting the fetching of next instructions in the instruction pipeline after a short running loop that may not follow the actual loop exit may outweigh the benefits of replaying the loop from the loop buffer. Therefore, only longer running loops may be profitable from a benefit versus cost standpoint in the absence of loop exit target prediction. In the presence of loop exit target prediction, detection and replay of even short running may yield a benefit.

In another exemplary aspect, if the predicted number of loop iterations and the loop exit branch are hard to predict, such as their predictions having a low confidence indicator, for example, the loop buffer circuit can alternatively replay the detected loop indefinitely as discussed above. However, if the loop buffer circuit also has a prediction of the exit target address of the loop, the loop buffer circuit can be configured to perform a selective partial pipeline flush of the instruction pipeline in response to the loop exit as a further optimization. This is because only the instructions in the pipeline older than the next instruction at the exit target address of the loop exit target prediction in the instruction pipeline have to be flushed.

In this regard, in one exemplary aspect a processor is provided. The processor includes an instruction processing circuit, comprising a loop buffer circuit. The loop buffer circuit is configured to detect a loop among a plurality of instructions in an instruction stream in an instruction pipeline to be executed. In response to detection of the loop in the instruction stream, the loop buffer circuit is also configured to predict a number of full iterations of the detected loop to be executed in the instruction pipeline as a loop iteration prediction, predict a loop exit branch of an instruction of the detected loop that will result in the detected loop being exited in the instruction pipeline as a loop exit branch prediction, and fully replay the detected loop in the instruction pipeline for the number of full iterations indicated by the loop iteration prediction. In response to a last full iteration of the detected loop being fully replayed in the instruction pipeline, the loop buffer circuit is also configured to partially replay the plurality of instructions in the detected loop to the instruction at the loop exit branch indicated by the loop exit branch prediction.

In another exemplary aspect, a method of replaying a loop in an instruction pipeline in a processor is provided. The method includes detecting a loop among a plurality of instructions in an instruction stream in an instruction pipeline to be executed. In response to detection of the loop in the instruction stream, the method also includes predicting a number of full iterations of the detected loop to be executed in the instruction pipeline as a loop iteration prediction, predicting a loop exit branch of an instruction of the detected loop that will result in the detected loop being exited in the instruction pipeline as a loop exit branch prediction, fully replaying the detected loop in the instruction pipeline for the number of full iterations indicated by the loop iteration prediction, and partially replaying the plurality of instructions in the detected loop to the instruction at the loop exit branch indicated by the loop exit branch prediction, in response to a last full iteration of the detected loop being fully replayed in the instruction pipeline.

In this regard, in one exemplary aspect, a processor is provided. The processor includes an instruction processing circuit comprising an instruction fetch circuit configured to fetch a plurality of instructions into an instruction pipeline as an instruction stream to be executed, and an execution circuit configured to execute the plurality of instructions in the instruction stream. The processor also includes a loop buffer circuit. The loop buffer circuit is configured to detect a loop among the plurality of instructions in the instruction stream in the instruction pipeline to be executed in the execution circuit, and replay the detected loop in the instruction pipeline. In response to replay of the detected loop in the instruction pipeline, the loop buffer circuit is also configured to instruct the instruction fetch circuit to halt fetching next instructions into the instruction pipeline, and predict an exit target address of the next instruction to be executed following exit of the detected loop in the instruction pipeline as a loop exit target prediction. The loop buffer circuit is also configured to instruct the instruction fetch circuit to start fetching next instructions into the instruction pipeline starting at the exit target address of the loop exit target prediction.

In another exemplary aspect, a method of fetching next instructions following a detected loop replayed in an instruction pipeline in a processor is provided. The method includes fetching a plurality of instructions into an instruction pipeline as an instruction stream to be executed. The method also includes detecting a loop among the plurality of instructions in the instruction stream in the instruction pipeline to be executed. The method also includes replaying the detected loop in the instruction pipeline. In response to replaying the detected loop in the instruction pipeline, the method also includes instructing an instruction fetch circuit to halt fetching next instructions into the instruction pipeline, and predicting an exit target address of a next instruction to be executed following exit of the detected loop in the instruction pipeline as a loop exit target prediction. The method also includes instructing the instruction fetch circuit to start fetching next instructions into the instruction pipeline starting at the exit target address of the loop exit target prediction.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a diagram of an exemplary loop of computer program instructions in an instruction stream;

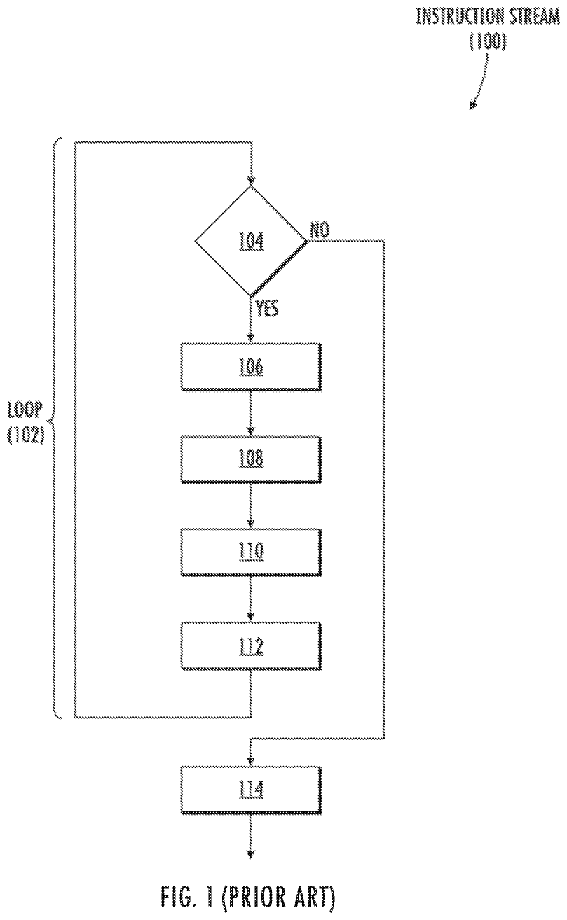

FIG. 2 is a diagram of an exemplary instruction processing circuit in a processor that includes one or more instruction pipelines for processing computer instructions for execution, and wherein the processor further includes a loop buffer circuit that includes a loop detection circuit configured to detect loops in the instruction stream in an instruction pipeline, and a loop replay circuit configured to capture detected loops and provide one or more loop characteristic predictions for replaying the loop to reduce or avoid under- or over-iterating of the loop;

FIG. 3 is a flowchart illustrating an exemplary process of the loop replay circuit, such as in FIG. 2, capturing detected loops and providing a loop iteration prediction and an exit branch prediction regarding the detected loop for controlling the number of replay iterations of the loop and its exit in an instruction pipeline;

FIG. 4 is a more detailed, exemplary diagram of a loop replay circuit that can be included in the loop buffer circuit in the processor in FIG. 2;

FIG. 5 is a block diagram of an exemplary loop iteration context prediction circuit for generating a contextual loop iteration prediction based on historical loop information;

FIG. 6 is a block diagram of an exemplary loop exit branch context prediction circuit for providing a contextual loop exit branch prediction based on historical loop information;

FIG. 7 is a flowchart illustrating an exemplary process of the loop replay circuit, such as in FIGS. 2 and 4, further providing a loop exit target prediction of the exit target address of the detected loop for controlling the next address to fetch new instructions into an instruction pipeline following the loop;

FIG. 8 is a block diagram of an exemplary loop exit target context prediction circuit for generating a contextual loop exit target prediction based on historical loop information; and

FIG. 9 is a block diagram of an exemplary processor-based system that includes a processor that includes an instruction processing circuit for executing instructions from program code, and wherein the processor can include a loop buffer circuit, including, but not limited to, the loop buffer circuits in FIGS. 2 and 4, and configured to detect and capture loops in the instruction stream in an instruction pipeline, and provide one or more loop characteristic predictions for replaying the loop to reduce or avoid under- or over-iterating of the loop.

### DETAILED DESCRIPTION

Exemplary aspects disclosed herein include loop buffering employing loop characteristic prediction in a processor for optimizing loop buffer performance The processor includes an instruction processing circuit configured to fetch computer program instructions (“instructions”) into an instruction stream in an instruction pipeline(s) to be processed and executed. Loops can be contained in the instruction stream. A loop is a sequence of instructions in the instruction stream that repeat sequentially in a back-to-back arrangement. The instruction processing circuit includes a loop buffer circuit that is configured to detect loops. In response to a detected loop, the loop buffer circuit is configured to capture (i.e., loop buffer) instructions in the detected loop and insert (i.e., replay) the captured loop instructions in the instruction pipeline for iterations of the loop. In this manner, the instructions in the loop do not have to be re-fetched and re-processed, for example, for the subsequent iterations of the loop. Thus, loop buffering can conserve power by not having to re-fetch and re-process instructions in the loop for subsequent iterations of the loop. In exemplary aspects, the loop buffer circuit is configured to predict the number of iterations that a detected loop in the instruction stream will be executed before the loop is exited, as a loop iteration prediction. The loop iteration prediction is a type of loop characteristic prediction. This is to reduce or avoid under- or over-iterating the loop replay. The loop iteration prediction is used to control the number of iterative replays of the loop in the instruction pipeline. For example, a design that chooses a fixed iteration assumption for controlling replay may more often under- or over-iterate loop replay. As another example, a design that chooses to indefinitely replay a loop until a detected exit will over-iterate loop replay. Under-iterating a loop replay results in instructions in the loop being re-fetched and re-processed in the instruction pipeline that otherwise could have been replayed, thus consuming additional power unnecessarily. Over-iterating a loop replay results in additional replay of iterations of the loop in the instruction pipeline that reduces processor performance by such additional iterations being processed unnecessarily.

A replayed loop in the instruction pipeline of the processor may exit without a full iteration. In other words, the last iteration of a loop may be a partial iteration where the loop is exited before all instructions in the loop are fully replayed. In this regard, in other exemplary aspects, the loop buffer circuit can also be configured to predict the loop exit branch of the detected loop as a loop exit branch prediction. The loop exit branch prediction is a type of loop characteristic prediction. The loop exit branch prediction can be used to assist the loop buffer circuit in predicting the exact number of full iterations of the loop to replayed and what instructions to replay for the last partial iteration of the loop. Predicting the number of loop iterations and the loop exit branch allows a more accurate prediction of the number of full iterations of the loop to be replayed in the instruction pipeline to further reduce or avoid under- or over-iterating of the loop replay. Providing a more accurate prediction of the loop iterations to be replayed before the loop is exited can reduce the overhead penalty that would be associated with inaccurately predicting loop iteration for replay of detected shorter loops. Providing a more accurate prediction of the loop iterations to be replayed before the loop is exited can also allow the loop buffer circuit to more accurately instruct the instruction fetch circuit when to resume the fetching and processing of new instructions following a detected loop. This can reduce or avoid instruction bubbles in the instruction pipeline. In this regard, the loop buffer circuit can be configured to instruct the instruction fetch circuit to resume fetching of new instructions following the loop exit based on the predicted loop exit branch of the loop.

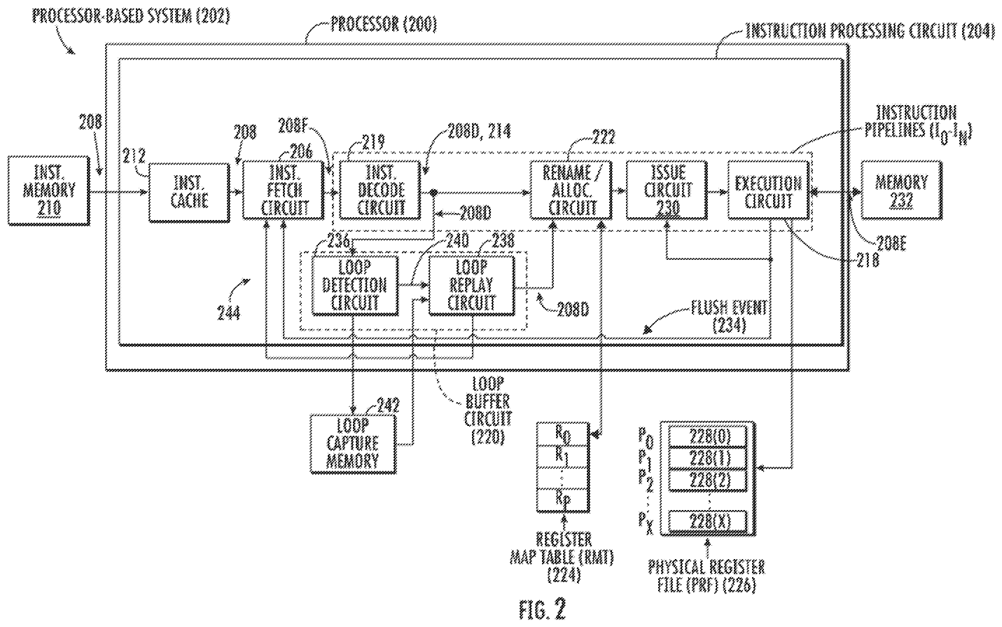

In this regard, FIG. 2 is a schematic diagram of an exemplary processor 200 in a processor-based system 202. The processor 200 includes an instruction processing circuit 204 that includes a circuit configured to fetch and process computer program code instructions (referred to as “instructions) to be executed. The instruction processing circuit 204 may be an out-of-order processor as an example. The instruction processing circuit 204 includes an instruction fetch circuit 206 configured to fetch instructions 208 from an instruction memory 210. The instruction memory 210 may be provided in or as part of the main memory in the processor-based system 202. An instruction cache 212 may also be provided in the processor-based system 202 to cache the instructions 208 fetched from the instruction memory 210 to reduce timing delays in the instruction fetch circuit 206. The instruction fetch circuit 206 in this example is configured to provide the instructions 208 as fetched instructions 208F into one or more instruction pipelines as an instruction stream 214 in the instruction processing circuit 204 to be pre-processed, before the fetched instructions 208F reach an execution circuit 218 to be executed. The instruction processing circuit 204 also includes an instruction decode circuit 219 configured to decode the fetched instructions 208F fetched by the instruction fetch circuit 206 into decoded instructions 208D to determine the instruction type and action required. The instruction type and action required encoded in the decoded instruction 208D may also be used to determine into which instruction pipeline I₀-I_{N} the decoded instructions 208D are placed.

The instructions 208 in the instruction stream 214 may contain loops. A loop is a sequence of instructions 208 in the instruction stream 214 that repeat sequentially in a back-to-back arrangement. A loop can be present in the instruction stream 214 as a result of a programmed software construct that is compiled into a loop among the instructions 208. A loop can also be present in the instruction stream 214 even if not part of a higher-level, programmed, software construct. If the instructions 208 that are part of a loop could be detected when such instructions 208 are processed in an instruction pipeline I₀-I_{N}, these instructions 208 could be captured and replayed into the instruction stream 214 without having to re-fetch and/or re-decode such instructions 208, for example, for the subsequent iterations of the loop.

In this regard, the instruction processing circuit 204 in this example includes a loop buffer circuit 220 to perform loop buffering. As discussed in more detail below, the loop buffer circuit 220 is configured to detect a loop in instructions 208 fetched into an instruction pipeline I₀-I_{N} as an instruction stream 214 to be processed and executed. The loop buffer circuit 220 is configured to detect loops among the instructions 208 in the instruction stream 214. In response to a detected loop, the loop buffer circuit 220 is configured to capture (i.e., loop buffer) the instructions 208 in the detected loop to be replayed to avoid or reduce the need to re-fetch the instructions in the detected loop, since the processing of these instructions 208 is repeated in the instruction pipeline I₀-I_{N}. In this regard, the loop buffer circuit 220 is configured to insert (i.e., replay) the captured loop instructions 208 in an instruction pipeline I₀-I_{N} for iterations of the loop. In this manner, the instructions 208 in the loop do not have to be re-fetched and/or re-decoded, for example, for the subsequent iterations of the loop. Thus, loop buffering can conserve power by the instruction fetch circuit 206 not having to re-fetch the instructions 208 in a detected loop for subsequent iterations of the loop. Loop buffering can also conserve power by the instruction decode circuit 219 not having to re-decode the instructions 208 in a detected loop for subsequent iterations of the loop.

In exemplary aspects, as discussed in more detail below, the loop buffer circuit 220 is configured to predict the number of iterations that a detected loop in the instruction stream 214 will be executed before the loop is exited, as a loop iteration prediction. The loop iteration prediction is a type of loop characteristic prediction. This is to reduce or avoid under- or over-iterating the loop replay. The loop iteration prediction is used to control the number of iterative replays of the loop in the instruction pipeline I₀-I_{N}. For example, a design that chooses a fixed iteration assumption for controlling replay may more often under- or over-iterate loop replay. As another example, a design that chooses to indefinitely replay a loop until a detected exit will over-iterate loop replay. Under-iterating a loop replay results in instructions 208 in the loop having to be re-fetched and/or re-decoded in the instruction pipeline I₀-I_{N} that otherwise could have been replayed, thus consuming additional power unnecessarily. Over-iterating loop results in additional replay of iterations of the loop in the instruction pipeline I₀-I_{N} that reduces processor performance by such additional iterations being processed unnecessarily.

A replayed loop in the instruction pipeline I₀-I_{N} of the processor 200 may exit without a full iteration. In other words, the last iteration of a loop may be a partial iteration where the loop is exited before all instructions 208 in the loop are fully replayed. In this regard, in other exemplary aspects, as discussed in more detail below, the loop buffer circuit 220 can also be configured to predict the loop exit branch of the detected loop as a loop exit branch prediction. The loop exit branch prediction is a type of loop characteristic prediction. The loop exit branch prediction can be used to assist the loop buffer circuit 220 in predicting the exact number of full iterations of the loop to replay and what instructions 208 in the loop to replay for a last partial iteration of the loop. Thus, predicting the number of loop iterations and the loop exit branch in combination allows a more accurate prediction of the number of full iterations and instructions 208 in the loop for a last partial iteration of the loop to be replayed in the instruction pipeline I₀-I_{N} to further reduce or avoid under- or over-iterating of the loop replay. Providing a more accurate prediction of the full and partial loop iterations of a loop to be replayed in the instruction pipeline I₀-I_{N} before the loop is exited from the instruction pipeline I₀-I_{N} can reduce the overhead penalty that would be associated with inaccurately predicting loop iteration for replay of shorter length, detected loops as an example.

Before discussing more exemplary details of the loop buffer circuit 220 using a loop iteration prediction and loop exit branch prediction of a detected loop processed in the instruction processing circuit 204 in FIG. 2 to control the full and partial replay iterations, additional exemplary details of the processor 200 are first discussed below. In this regard, with reference to the processor 200 in FIG. 2, once fetched instructions 208F are decoded into decoded instructions 208D by the instruction decode circuit 219, the decoded instructions 208D are provided to a rename/allocate circuit 222 in the instruction processing circuit 204. The rename/allocate circuit 222 is configured to determine if any register names in the decoded instructions 208D need to be renamed to break any register dependencies that would prevent parallel or out-of-order processing. The rename/allocate circuit 222 is also configured to call upon a register map table (RMT) 224 to rename a logical source register operand and/or write a destination register operand of a decoded instruction 208D to available physical registers P₀-P_{X} in a physical register file (PRF) 226. The RMT 224 contains a plurality of mapping entries each mapped to (i.e., associated with) a respective logical register R₀-R_{P}. The mapping entries are configured to store information in the form of an address pointer to point to a physical register P₀-P_{X} in the PRF 226. Each physical register P₀-P_{X} in the PRF 226 contains a data entry 228(0)-228(X) configured to store data for the source and/or destination register operand of a decoded instruction 208D.

With continuing reference to FIG. 2, an issue circuit 230 in the instruction pipeline I₀-I_{N} dispatches decoded instructions 208D when ready (i.e., when their source operands are available) to the execution circuit 218 after identifying and arbitrating among decoded instructions 208D that have all their source operations ready. The produced result(s) from execution of the decoded instructions 208D are written back to memory 232 and/or to the PRF 226 based on whether the destination of the executed instruction 208E is to memory or a logical register R₀-R_{P}. If the instructions 208F, 208D are no longer valid for any reasons, such as due to a resolved misprediction branch instruction, the execution circuit 218 is configured to issue a flush event 234 to the instruction fetch circuit 206 to indicate which new instructions 208 to fetch.

As discussed above, the loop buffer circuit 220 is configured to predict the number of iterations that a detected loop in the instruction stream 214 will be executed before the loop is exited, as a loop iteration prediction as a type of loop characteristic. As also discussed above, the loop buffer circuit 220 can also be configured to predict the loop exit branch of the detected loop as a loop exit branch prediction as another type of loop characteristic prediction. The loop buffer circuit 220 can use the loop iteration prediction in combination with the loop exit branch prediction to more accurately and precisely control the replay of a detected loop in the instruction stream 214. The loop iteration prediction can be used by the loop buffer circuit 220 to control the number of full iterations of the loop replayed in the instruction stream 214. The loop exit branch prediction may be used by the loop buffer circuit 220 to control what instructions 208 in the loop to replay for a last partial iteration of the loop in the instruction stream 214. Thus, predicting the number of loop iterations and the loop exit branch in combination allows a more accurate prediction of the number of full iterations and instructions 208 in the loop for a last partial iteration of the loop to be replayed in the instruction pipeline I₀-I_{N} to further reduce or avoid under- or over-iterating of the loop replay. Providing a more accurate prediction of the full and partial loop iterations of a loop to be replayed in the instruction pipeline I₀-I_{N} before the loop is exited from instruction pipeline I₀-I_{N} can reduce the overhead penalty that would be associated with inaccurately predicting loop iteration for replay of shorter length, detected loops as an example.

In this regard, as shown in FIG. 2, in this example, the loop buffer circuit 220 in the instruction processing circuit 204 of the processor 200 includes a loop detection circuit 236 and a loop replay circuit 238. The loop detection circuit 236 is configured to detect a loop among the instructions 208F, 208D in the instruction stream 214 to be executed. In this regard, in this example, the loop detection circuit 236 is communicatively coupled to the output of the instruction decode circuit 219 in an instruction pipeline I₀-I_{N} to receive the decoded instructions 208D. The loop detection circuit 236 is configured to receive the decoded instructions 208D and analyze the decoded instructions 208D to determine if there are any loops in the decoded instructions 208D. If the loop detection circuit 236 detects a loop in the decoded instructions 208D in the instruction stream 214, the loop detection circuit 236 issues a loop detect indicator 240. The loop detection circuit 236 may also provide the instructions 208D in the detected loop to the loop replay circuit 238. Alternatively, the loop detection circuit 236 may store the captured decoded instructions 208D in the detected loop in a memory structure, such as loop capture memory 242, for example, that can be accessed by the loop replay circuit 238. The loop replay circuit 238 is configured to perform loop characteristic predictions to control the replay of the detected loop in response to the loop detect indicator 240 indicating a detected loop. In this regard, the loop replay circuit 238 is configured to predict a number of full iterations of the detected loop to be executed in the instruction pipeline I₀-I_{N} as a loop iteration prediction. The loop replay circuit 238 is also configured to predict a loop exit branch of an instruction 208D of the detected loop that will result in the detected loop being exited in the instruction pipeline I₀-I_{N} as a loop exit branch prediction. The loop replay circuit 238 is then configured to fully replay the detected loop in the instruction pipeline I₀-I_{N} for a number of full iterations indicated by the loop iteration prediction. The loop replay circuit 238 is configured to inject or insert the instruction 208D for the loop in the instruction pipeline I₀-I_{N} to be processed and executed. In this example, the loop replay circuit 238 is configured to inject or insert the instruction 208D for the loop in the instruction pipeline I₀-I_{N} after the instruction decode circuit 219 since there is not a need to re-decode the fetched instructions 208F in the detected loop. In this example, the loop replay circuit 238 is configured to inject or insert the instruction 208D for the loop in the instruction pipeline I₀-I_{N} before the rename/allocate circuit 222 since the processor 200 in this example is an out-of-order processor. Thus, the decoded instructions 208D from the detected loop to be replayed may be processed and/or executed out-of-order according to the issuance of the decoded instructions 208D by the issue circuit 230.

After the loop has been replayed for the number of full iterations indicated by the loop iteration prediction, the loop replay circuit 238 is then configured to partially replay the instructions 208D in the detected loop to the instruction at the loop exit branch indicated by the loop exit branch prediction. The loop exit branch of a detected loop is the location of the branch instruction 208D in the loop that results in an exit of the loop in the instruction pipeline I₀-I_{N} when executed. In this example, since the exit branch of the loop may not be absolutely known before the loop is fully processed, the loop replay circuit 238 is configured to make a prediction of the loop exit branch as the loop exit branch prediction. For example, the detected loop may have multiple exits. The loop replay circuit 238 is configured to insert instructions 208D from the detected loop into the instruction pipeline I₀-I_{N} to be placed up until and including the instruction 208 at the predicted loop exit branch according to the loop exit branch prediction for the last partial iteration of the loop. Controlling the replay of the detected loop according to the combination of the loop iteration prediction and the loop exit branch prediction allows a more accurate prediction of the number of full iterations and instructions 208D in the loop for a last partial iteration of the loop to be replayed in the instruction pipeline I₀-I_{N} to further reduce or avoid under- or over-iterating of the loop replay. Providing a more accurate prediction of the full and partial loop iterations of a loop to be replayed in the instruction pipeline I₀-I_{N} before the loop is exited from the instruction pipeline I₀-I_{N} can reduce the overhead penalty that would be associated with inaccurately predicting loop iteration for replay of shorter length, detected loops as an example.

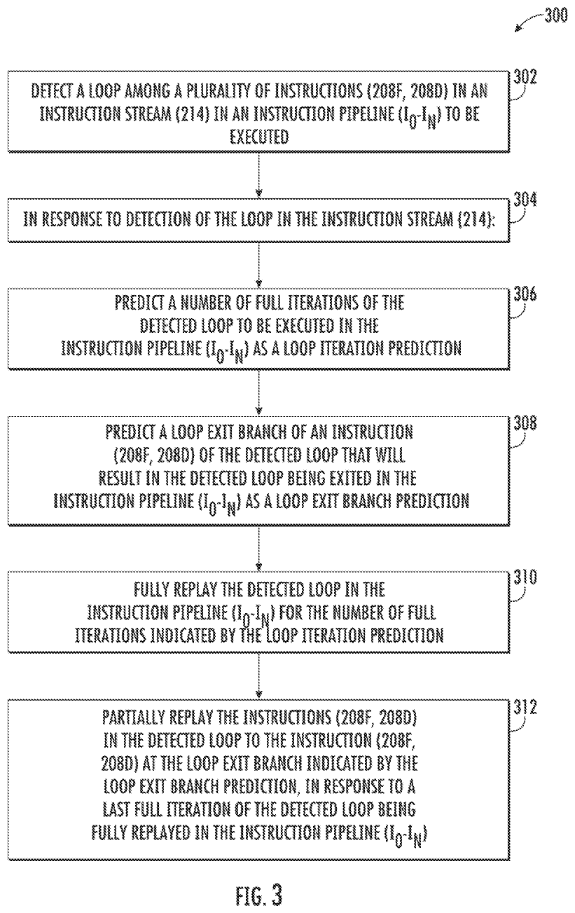

FIG. 3 is a flowchart illustrating an exemplary process 300 of the loop buffer circuit 220 in FIG. 2 capturing detected loops for controlling the number of full iteration and partial iteration replays of the loop. The loop detection circuit 236 captures instructions 208D in the instruction pipeline I₀-I_{N}. The loop replay circuit 238 provides a loop iteration prediction and an exit branch prediction of the detected loop to control the number of full iteration and partial iteration replays of the loop. The exemplary process 300 in FIG. 3 is discussed in conjunction with the loop buffer circuit 220 and the instruction processing circuit 204 in FIG. 2.

In this regard, as shown in FIG. 3, the process 300 starts by the loop buffer circuit 220 or the loop detection circuit 236 detecting a loop among a plurality of instructions 208F, 208D in an instruction stream 214 in an instruction pipeline I₀-I_{N} to be executed (block 302 in FIG. 3). In response to detection of the loop in the instruction stream 214 (block 304 in FIG. 3), the loop buffer circuit 220 or the loop replay circuit 238 predicts a number of full iterations of the detected loop to be executed in the instruction pipeline I₀-I_{N} as a loop iteration prediction (block 306 in FIG. 3). The loop buffer circuit 220 or the loop replay circuit 238 also predicts a loop exit branch of an instruction 208F, 208D of the detected loop that will result in the detected loop being exited in the instruction pipeline I₀-I_{N} as a loop exit branch prediction (block 308 in FIG. 3). The loop buffer circuit 220 or the loop replay circuit 238 fully replays the detected loop in the instruction pipeline I₀-I_{N} for the number of full iterations indicated by the loop iteration prediction (block 310 in FIG. 3). The loop buffer circuit 220 or the loop replay circuit 238 partially replays the instructions 208F, 208D in the detected loop to the instruction 208F, 208D at the loop exit branch indicated by the loop exit branch prediction, in response to a last full iteration of the detected loop being fully replayed in the instruction pipeline I₀-I_{N} (block 312 in FIG. 3).

Thus, the loop buffer circuit 220 in the instruction processing circuit 204 in FIG. 2 can use the loop iteration prediction and the loop exit branch prediction in combination to provide a more accurate prediction of the loop iterations to be replayed in the instruction pipeline I₀-I_{N}. This also allows the loop buffer circuit 220 and its loop replay circuit 238 to more accurately instruct the instruction fetch circuit 206 when to resume the fetching and processing of new instructions 208 following a detected loop. For example, if the loop replay circuit 238 were not configured to partially replay the detected loop based on the loop exit branch prediction for the last partial iteration of the loop, the last iteration of the loop may be fully replayed. The execution circuit 218 would eventually detect the exit of the loop and not execute the instructions 208D after the loop is exited. However, the issuance of the flush event 234 by the execution circuit 218 may be delayed until after the loop exit is detected. Thus, the instruction fetch circuit 206 would not be instructed to fetch next instructions to be processed following the loop until the loop exit is detected in this scenario. This delay can introduce voids or instruction bubbles in the instruction pipeline I₀-I_{N} where stages and/or circuits in the instruction pipeline I₀-I_{N} are stalled until the next instructions following the loop are fetched into the instruction pipeline I₀-I_{N} and decoded and processed. However, by the loop replay circuit 238 being able to predict the loop exit branch of the replayed loop, the loop replay circuit 238 is able to determine more accurately the instruction 208D in the loop at which the loop will be exited. In response to replaying the instruction 208D of the predicted loop exit branch into the instruction pipeline I₀-I_{N}, the loop replay circuit 238 can be configured to instruct the instruction fetch circuit 206 to resume fetching of new instructions 208 following the loop exit based on the predicted loop exit branch of the loop. In this regard, the loop replay circuit 238 can be configured to issue a fetch resumption indicator 244 to the instruction fetch circuit 206 to cause the instruction fetch circuit 206 to resume fetching of new instructions 208. In this manner, the instruction pipeline I₀-I_{N} will have already resumed fetching of next instructions 208D following the exit of the loop before the exit is detected by the execution circuit 218 to reduce or avoid pipeline bubbles.

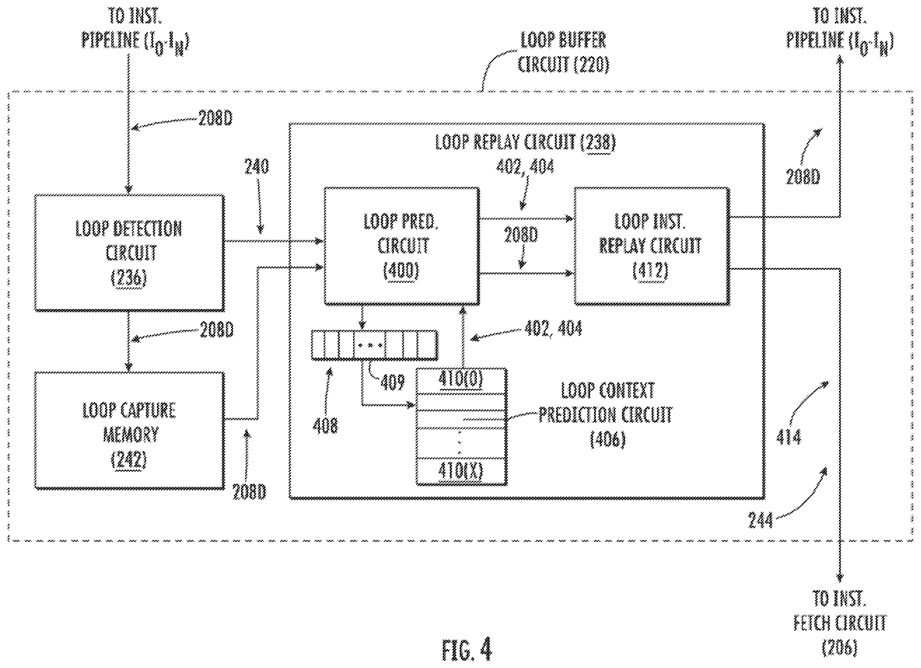

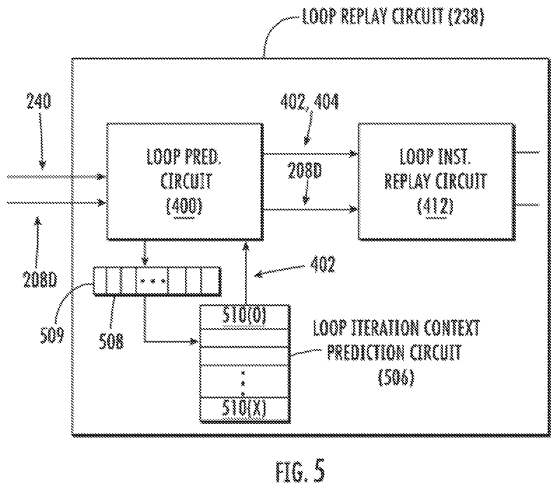

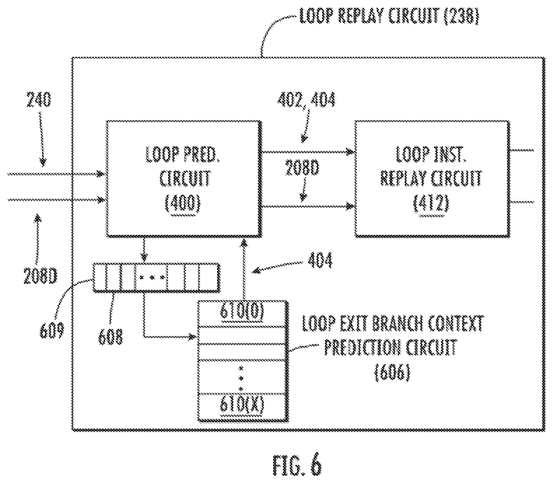

FIG. 4 is a diagram of additional exemplary details of components and functions that can be provided in the loop buffer circuit 220 in the processor 200 in FIG. 2 for additional discussion. As shown in FIG. 4, the loop detection circuit 236 in the loop buffer circuit 220 receives decoded instructions 208D from the instruction pipeline I₀-I_{N} to detect loops in the instruction stream 214. In this example, the loop detection circuit 236 is configured to capture the instructions 208D in a loop capture memory 242. In this manner, if a loop is detected in the instructions 208D, the instructions 208D are stored to be able to be replayed by the loop replay circuit 238. As discussed above, in response to a detected loop, the loop detection circuit 236 is configured to issue a loop detect indicator 240 to the loop replay circuit 238 to indicate the detection of the loop. In this example, the loop replay circuit 238 includes a loop prediction circuit 400 that is configured to receive the loop detect indicator 240. In response to the loop detect indicator 240 indicating a detected loop, the loop prediction circuit 400 is configured to retrieve the instructions 208D in the loop from the loop capture memory 242. The loop prediction circuit 400 is configured to generate the loop iteration prediction and the loop exit branch prediction for controlling the replay of the loop in the instruction pipeline I₀-I_{N}, as previously discussed. In this example, the loop prediction circuit 400 is configured to receive a loop iteration prediction 402 and/or a loop exit branch prediction 404 from a loop context prediction circuit 406 based on an index of the loop context prediction circuit 406 by a loop context information 408 stored in a loop history register 409. In this example, the loop context prediction circuit 406 includes a plurality of prediction entries 410(0)-410(X) that are each configured to store a prediction value. As will be discussed in regard to FIGS. 5 and 6, there may be a separate loop context prediction circuit 406 provided to make predictions for each of the loop iteration prediction 402 and loop exit branch prediction 404. The loop context information 408 is information that is based on some historical context information regarding at least one previously detected and replayed loop in the instruction pipeline I₀-I_{N}. In this manner, predictions about the current detected loop are based on historical context of the replay of previous loops. This historical context information may include information about the current detected loop as well. This historical context information may include global information about previously replayed loops or local information about previous replays of the current detected loop.

The loop prediction circuit 400 is configured to provide the loop iteration prediction 402 and/or a loop exit branch prediction 404 to a loop instruction replay circuit 412. The loop instruction replay circuit 412 uses the loop iteration prediction 402 and/or a loop exit branch prediction 404 to control the replay of the detected loop. In this example, as discussed above, the loop instruction replay circuit 412 uses the loop iteration prediction 402 to determine the number of full iterations of the loop to be replayed in the instruction pipeline I₀-I_{N}. Also in this example, as discussed above, the loop instruction replay circuit 412 uses the loop exit branch prediction 404 to determine the instructions 208D to replay in the instruction pipeline I₀-I_{N} in a last partial replay of the loop. In this example, the loop instruction replay circuit 412 is configured to issue a fetch halt indicator 414 instructing the instruction fetch circuit 206 in FIG. 2 to halt fetching of next instructions 208 due to the replay of the loop. This is to conserve power to avoid the instruction fetch circuit 206 from having to re-fetch the loop instructions 208 that will be reiterated in replay as discussed above. This may reduce or avoid the fetching of invalid instructions 208 into the instruction pipeline I₀-I_{N} that may not follow the loop exit that would have to be flushed on loop exit. The loop instruction replay circuit 412 can be configured to issue the fetch resumption indicator 244 to instruct the instruction fetch circuit 206 in FIG. 2 to resume fetching of next instructions 208 into the instruction pipeline I₀-I_{N} following the replay of the loop. Alternatively, the loop instruction replay circuit 412 can be configured to issue the fetch resumption indicator 244 to instruct the instruction fetch circuit 206 in FIG. 2 to resume fetching of next instructions 208 into the instruction pipeline I₀-I_{N} based on when the exit of the loop is detected in the instruction processing circuit 204. Alternatively, the loop instruction replay circuit 412 can be configured to issue the fetch resumption indicator 244 to instruct the instruction fetch circuit 206 in FIG. 2 to resume fetching of next instructions 208 into the instruction pipeline I₀-I_{N} based on an exit lead time earlier than the presumed actual exit of the loop. This would give time for the instruction fetch circuit 206 to start fetching instructions 208 to fill the instruction pipeline I₀-I_{N} before the loop actually exits to avoid stalls or pipeline bubbles in the instruction pipeline I₀-I_{N}, as discussed above.

As discussed above, the loop replay circuit 238 in FIG. 4 is configured to generate the loop iteration prediction 402 and the loop exit branch prediction 404 to control replay of a detected loop. Thus, it is desired that the loop replay circuit 238 be able to make an accurate prediction of the loop iteration prediction 402 and the loop exit branch prediction 404 for a more accurate determination of the number of full and partial iterations of a detected loop to be replayed. In this regard, FIG. 5 illustrates exemplary detail of a loop iteration context prediction circuit 506 that can be provided in the loop replay circuit 238 in FIGS. 2 and 4 for generating a contextual loop iteration prediction 402 based on historical loop information. The loop iteration context prediction circuit 506 can be used as the loop context prediction circuit 406 in FIG. 4. In this regard, in this example, the loop prediction circuit 400 is configured to receive the loop iteration prediction 402 from the loop context prediction circuit 406 based on an index of the loop iteration context prediction circuit 506 by a loop iteration context information 508. In this example, the loop iteration context prediction circuit 506 includes a plurality of prediction entries 510(0)-510(X) that are each configured to store a loop iteration prediction value. The loop iteration context information 508 is information that is based on some historical loop iteration context information regarding at least one previously detected and replayed loop in the instruction pipeline I₀-I_{N}. In this manner, predictions about the current detected loop are based on historical loop iteration context of the replay of previous loops. This historical loop iteration context information 508 may include information about the current detected loop as well. This historical loop iteration context information 508 may include global information about previously replayed loops or local information about previous replays of the current detected loop.

In one example, the loop iteration context information 508 is based on a program counter (PC) of at least one instruction 208D of one or more previously detected loops. The loop iteration context information 508 is stored in a loop history register 509. The loop iteration context information 508 is also based on a PC of at least one instruction 208D in at least one previously detected and replayed loop. The loop iteration context information 508 may be appended or hashed with the PC of at least one instruction 208D in the current detected loop. In this manner, the loop iteration context information 508 is based on context information from the current detected loop and one or more previously detected and replayed loops. The loop prediction circuit 400 can be configured to edit the loop history register 509 based on the loop iteration context information 508 for detected loops when detected. When a loop is currently detected, the loop replay circuit 238 can also be configured to edit the loop history register 509 based on the loop iteration context information 508 for the current detected loop. The loop iteration context information 508 in the loop history register 509 can be used to index the loop iteration context prediction circuit 506 to access a prediction entry 510(0)-510(X) therein that has a loop iteration prediction stored therein. The loop prediction circuit 400 can set the loop iteration prediction 402 to the loop iteration prediction entry in the indexed and accessed prediction entry 510(0)-510(X) in the loop iteration context prediction circuit 506.

Similarly, as discussed above, the loop replay circuit 238 in FIG. 4 is configured to generate the loop exit branch prediction 404 to control the partial replay of a last iteration of a detected loop. Thus, it is desired that the loop replay circuit 238 be able to make an accurate prediction of the loop exit branch prediction 404 for a more accurate determination of instructions 208D in the detected loop to be replayed for the last partial iteration of the loop. In this regard, FIG. 6 illustrates exemplary detail of a loop exit branch context prediction circuit 606 that can be provided in the loop replay circuit 238 in FIGS. 2 and 4 for generating a contextual loop exit branch prediction 404 based on historical loop information. The loop exit branch context prediction circuit 606 can be used as the loop context prediction circuit 406 in FIG. 4. In this regard, in this example, the loop prediction circuit 400 is configured to receive the loop exit branch prediction 404 from the loop exit branch context prediction circuit 606 based on an index of the loop exit branch context prediction circuit 606 by a loop exit branch context information 608. In this example, the loop exit branch context prediction circuit 606 includes a plurality of prediction entries 610(0)-610(X) that are each configured to store a loop exit branch prediction value. The loop exit branch context information 608 is information that is based on some historical loop iteration context information regarding at least one previously detected and replayed loop in the instruction pipeline I₀-I_{N}. In this manner, predictions about the currently detected loop are based on historical loop context of the replay of previous loops. This historical loop exit branch context information 608 may include information about the current detected loop as well. This historical loop exit branch context information 608 may include global information about previously replayed loops or local information about previous replays of the current detected loop.

In one example, the loop exit branch context information 608 can be based on a loop path history of one or more previously detected loops. The loop exit branch context information 608 can also be based on loop exit branch position history of the position histories of exit branches in previously detected loops. The loop exit branch context information 608 can also be based on a loop exit PC of the exit PC in previously detected loops. The loop exit branch context information 608 is stored in a loop history register 609. The loop exit branch context information 608 may be appended or hashed with the loop path history for the current detected loop. In this manner, the loop exit branch context information 608 is based on context information from the current detected loop and one or more previously detected and replayed loops. The loop prediction circuit 400 can be configured to edit the loop history register 609 based on the loop exit branch context information 608 for detected loops when detected. When a loop is currently detected, the loop replay circuit 238 can also be configured to edit the loop history register 609 based on the loop exit branch context information 608 for the current detected loop. The loop exit branch context information 608 in the loop history register 609 can be used to index the loop exit branch context prediction circuit 606 to access a prediction entry 610(0)-610(X) therein that has a loop exit branch prediction stored therein. The loop prediction circuit 400 can set the loop exit branch prediction 404 to the loop exit branch prediction entry in the indexed and accessed prediction entry 610(0)-610(X) in the loop exit branch context prediction circuit 606.

As discussed above, the loop buffer circuit 220 in FIGS. 2 and 4 can be configured to instruct the instruction fetch circuit 206 to halt fetching and processing of new instructions 208 while a detected loop is being replayed to conserve power. However, the replayed loop may have multiple exit points that could be taken during the last partial iteration of the replayed loop. However, the next address from which to fetch instructions 208 following a loop exit is not necessarily the next sequential instruction after the loop. This can cause instructions 208 that do not follow the actual exit of the loop to be fetched and inserted into the instruction pipeline I₀-I_{N}, only to have to be flushed when the replay of the loop exits.

In this regard, in other exemplary aspects, the loop buffer circuit 220 in FIGS. 2 and 4 can also be configured to predict the exit target address of the loop as a loop exit target prediction. The loop exit target prediction is a type of loop characteristic prediction. As discussed below, the loop buffer circuit 220 can use the predicted exit target address to instruct the instruction processing circuit 204 as to the starting address to fetch new instructions 208 following the loop exit when instruction fetching is resumed. The loop buffer circuit 220 could be configured to instruct the immediate resumption of instruction 208 fetching during loop replay without having to wait until the loop is exited in replay. Otherwise, if instruction 208 fetching is resumed before the loop is exited, it may be more likely that the instruction pipeline I₀-I_{N} will have to be flushed if instruction 208 fetching is resumed before loop exit due to fetching of instructions 208 that do not follow the correct next address following the loop exit. The loop buffer circuit 220 can also be configured to instruct resumption of instruction fetching to the instruction processing circuit 204 following a detected loop based on a defined period of time before the loop is exited based on the predicted number of loop iterations from the predicted number of loop iterations and the loop exit branch as a further optimization. Predicting the loop exit target of a replayed loop may allow for loop buffer design to detect and replay shorter loops (as opposed to only replaying longer loops). This is because otherwise, shorter replayed loops may more often lead to instruction pipeline I₀-I_{N} flushing that would outweigh the benefit of loop replay for shorter loops due to the reduced likelihood the next instructions 208 in the instruction pipeline I₀-I_{N} following the loop do not start at the actual exit of the loop.

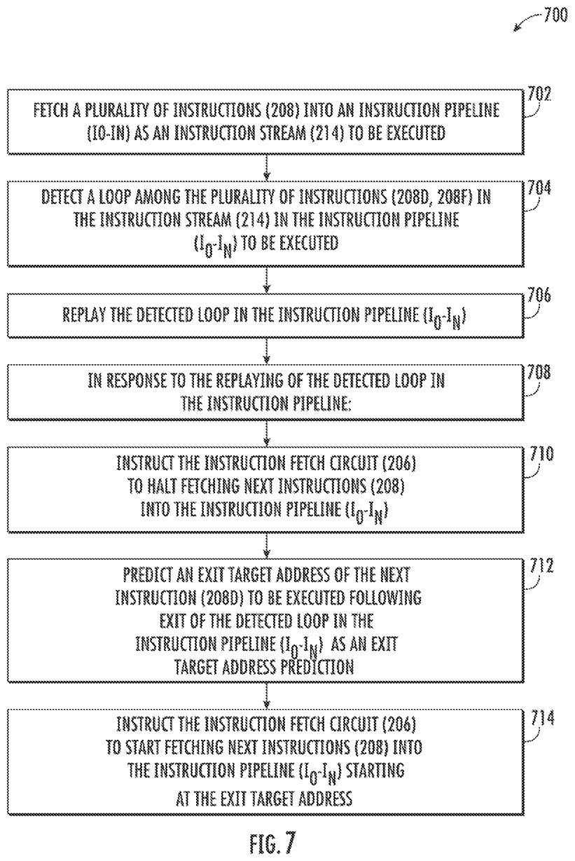

FIG. 7 is a flowchart illustrating an exemplary process 700 of the loop replay circuit 238, such as in FIGS. 2 and 4, providing a loop exit target prediction of the exit target address of the detected loop. The loop exit target prediction can be used to control the next address of the instruction processing circuit 204 to fetch new instructions 208 into the instruction pipeline I₀-I_{N} following exit of the loop. In this regard, as shown in FIG. 7, as discussed above, the instruction processing circuit 204 fetches instructions 208 into the instruction pipeline I₀-I_{N} as an instruction stream 214 to be executed (block 702 in FIG. 7). The loop buffer circuit 220, and more particularly its loop detection circuit 236, detects a loop among the plurality of instructions 208D, 208F in the instruction stream 214 in the instruction pipeline I₀-I_{N} to be executed (block 704 in FIG. 7). The loop buffer circuit 220, and more particularly its loop replay circuit 238, replays the detected loop in the instruction pipeline I₀-I_{N} (block 706 in FIG. 7). As discussed above, this may include replaying the detected loop based on the loop iteration prediction and loop exit branch prediction to control the number of full iterations and the last iteration of the replay of the loop.

In response to the replaying of the detected loop in the instruction pipeline I₀-I_{N} (block 708 in FIG. 7), the loop buffer circuit 220 is configured to instruct the instruction fetch circuit 206 to halt fetching next instructions 208 into the instruction pipeline I₀-I_{N} (block 710 in FIG. 7). For example, as previously discussed, this can involve the loop replay circuit 238 issuing the loop detect indicator 240 as shown in FIG. 4 to indicate the detection of the loop to cause the instruction processing circuit 204 to halt fetching of new instructions 208. The loop buffer circuit 220, and its loop replay circuit 238, for example, can then predict an exit target address of the next instruction 208D to be executed following exit of the detected loop in the instruction pipeline I₀-I_{N} as a loop exit target prediction (block 712 in FIG. 7). The loop buffer circuit 220, and its loop replay circuit 238, for example, can then instruct the instruction fetch circuit 206 to start fetching next instructions 208 into the instruction pipeline I₀-I_{N} starting at the exit target address (block 714 in FIG. 7). For example, as previously discussed, this can involve the loop replay circuit 238 issuing the fetch resumption indicator 244 as shown in FIG. 4.

As discussed above, the loop buffer circuit 220, and its loop replay circuit 238 for example, can be configured to issue the fetch resumption indicator 244 to cause the instruction fetch circuit 206 to resume fetching of next instructions 208. The instruction fetch circuit 206 may be instructed to resume the fetching of next instructions 208 immediately after a loop is detected, a determined lead time before the loop exits, or after the replayed loop is exited, as examples. In the event that the instruction fetch circuit 206 is instructed to fetch next instructions 208 before the replayed loop is actually exited, the instruction fetch circuit 206 could also be instructed to hold any fetched next instructions 208F from being processed unnecessarily until the exit of the loop is actually detected in the instruction pipeline I₀-I_{N}. Once the exit of the replayed loop is detected, the next fetched instructions 208F in the instruction pipeline I₀-I_{N} could then be released to be processed. In this manner, fetched next instructions 208F are not unnecessarily processed and power is not consumed in doing so, when these fetched instructions 208D cannot be executed until after the replayed loop is exited. In one example, the next fetched instructions 208F in the instruction pipeline I₀-I_{N} could be held in the instruction fetch circuit 206 or at this stage in the instruction pipeline I₀-I_{N}. In one example, the next fetched instructions 208F in the instruction pipeline I₀-I_{N} could held in the instruction decode circuit 219 or at this stage in the instruction pipeline I₀-I_{N}.

As discussed above, the loop replay circuit 238 in FIG. 2 is configured to generate a loop exit target prediction to control the next instructions 208 to be fetched for processing after exit of a replayed loop. Thus, it is desired that the loop replay circuit 238 be able to make an accurate prediction of the loop exit target prediction for a more accurate determination of the exit target address to reduce or avoid flushing of the instruction pipeline I₀-I_{N}. If next instructions 208D fetched behind the replayed loop instructions 208D do not start at the exit target address of the replayed loop, then these next instructions 208D may have to be flushed out of the instruction pipeline I₀-I_{N} thus consuming power and reducing performance, as discussed above.

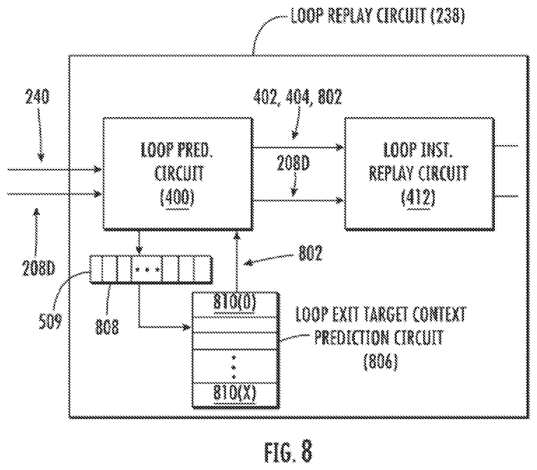

In this regard, FIG. 8 illustrates exemplary detail of the loop replay circuit 238 in FIG. 2 and the alternative loop replay circuit 238 illustrated in FIG. 4. The loop replay circuit 238 in this example includes a loop exit target context prediction circuit 806 that can be provided in the loop replay circuit 238 for generating a contextual loop exit target prediction 802 based on historical loop information. The loop exit target context prediction circuit 806 can be used as the loop context prediction circuit 406 in FIG. 4. In this regard, in this example, the loop prediction circuit 400 in FIG. 8 is configured to receive the loop exit target prediction 802 from the loop exit target context prediction circuit 806 based on an index of the loop exit target context prediction circuit 806 by a loop exit target context information 808. In this example, the loop exit target context prediction circuit 806 includes a plurality of prediction entries 810(0)-810(X) that are each configured to store a loop exit target prediction value. The loop exit target context information 808 is information that is based on some historical loop exit target context information regarding at least one previously detected and replayed loop in the instruction pipeline I₀-I_{N}. In this manner, predictions about the currently detected loop are based on historical loop exit target context of the replay of previous loops. This historical loop exit target context information 808 may include exit target information about the current detected loop as well. This historical loop exit target context information 808 may include global information about previously replayed loops or local information about previous replays of the current detected loop.

In one example, the loop exit target context information 808 may be appended or hashed with loop exit target context information 808 for the current detected loop, which may be based on the loop exit target prediction 802 as an example.

In this manner, the loop exit target context information 808 is based on loop exit target context information 808 from the current detected loop and one or more previously detected and replayed loops. The loop prediction circuit 400 can be configured to edit the loop history register 509 based on the loop exit target context information 808 for detected loops when detected. When a loop is currently detected, the loop replay circuit 238 can also be configured to edit the loop history register 509 based on the loop exit target context information 808 for the current detected loop. The loop exit target context information 808 in the loop history register 509 can be used to index the loop exit target context prediction circuit 806 to access a prediction entry 810(0)-810(X) therein that has a loop exit target prediction stored therein. The loop prediction circuit 400 can set the loop exit target prediction 802 to the loop exit target prediction entry in the indexed and accessed prediction entry 810(0)-810(X) in the loop exit target context prediction circuit 806.

In another exemplary aspect, if the predicted number of loop iterations and the loop exit branch of a detected loop are hard to predict, such as their predictions having a low confidence indicator, for example, the loop buffer circuit 220 in FIG. 2 can alternatively replay the detected loop indefinitely instead of a fixed number of iterations based on the loop iteration prediction. However, if the loop buffer circuit 220 also has a prediction of the exit target address of the loop as discussed above, the loop buffer circuit 220 can be configured to perform a selective partial pipeline flush of the instruction pipeline I₀-I_{N} in response to the loop exit as a further optimization. This is because only the instructions 208 in the instruction pipeline I₀-I_{N} older than the next instruction 208F, 208D at the predicted loop exit target address in the instruction pipeline I₀-I_{N} have to be flushed. It may be less expensive from a power and performance standpoint to perform a selective flush of the instruction pipeline I₀-I_{N} than to recover from an incorrect prediction of the loop iterations and/or the loop exit branch of a detected loop. An incorrect loop iteration prediction and/or loop exit branch prediction may cause the replayed loop to under- or over-iterate as well as causing a selective flush of the instruction pipeline I₀-I_{N} to recover. However, with the knowledge of the loop exit target prediction, the risk of having to flush the instruction pipeline I₀-I_{N} is reduced. This in turn reduces the risk of additional flushing of the instruction pipeline I₀-I_{N} if the loop is replayed indefinitely as opposed to a predicted number of iterations, which may be inaccurate.

In this regard, the loop buffer circuit 220 in FIG. 2 can be configured to determine if the loop iteration prediction is associated with a low prediction confidence, meaning that the loop iteration prediction may not be as accurate. A low confidence indicator may be determined if a confidence indicator associated with the loop iteration prediction is less than a defined confidence threshold value. For example, confidence indicators may be associated with the loop iteration predictions in the prediction entries 510(0)-510(X) in the loop iteration context prediction circuit 506 in FIG. 5. In response to the determining the loop iteration prediction is associated with a low confidence indicator, the loop replay circuit 238 can be configured to replay the detected loop indefinitely instead of the number of full iterations predicted by the loop iteration prediction. The loop replay circuit 238 can then be configured to detect the exit of the replay of the detected loop in the instruction pipeline I₀-I_{N}. In response to not detecting the exit of the detected loop in replay in the instruction pipeline I₀-I_{N}, loop replay circuit 238 can continue to replay the detected loop indefinitely until the loop is detected is actually exiting in the instruction pipeline I₀-I_{N}.

The loop buffer circuit 220 in FIG. 2 can also be configured to determine if the loop iteration prediction and the loop exit branch predictions are associated high prediction confidence, meaning that the loop iteration and loop exit branch predictions may be known to more likely be accurate. A high confidence indicator may be determined if a confidence indicator associated with the loop iteration prediction exceeds a defined confidence threshold value. For example, confidence indicators may be associated with the loop iteration predictions in the prediction entries 510(0)-510(X) in the loop iteration context prediction circuit 506 in FIG. 5 and the loop exit branch in the prediction entries 610(0)-610(X) in the loop exit branch context prediction circuit 606 in FIG. 6. In response to the determining the loop iteration prediction and loop exit branch predictions are associated with high confidence indicators, the loop replay circuit 238 can be configured to cause the next fetched instructions 208D to be released in the instruction pipeline I₀-I_{N} to the execution circuit 218 to be executed. This can be done without waiting to detect the loop exit. This is because there is a high confidence that the number of full and partial iterations of the replayed loop were accurate and thus the next fetched instructions 208D starting at the loop exit target are less likely to have to be flushed in the instruction pipeline I₀-I_{N}.

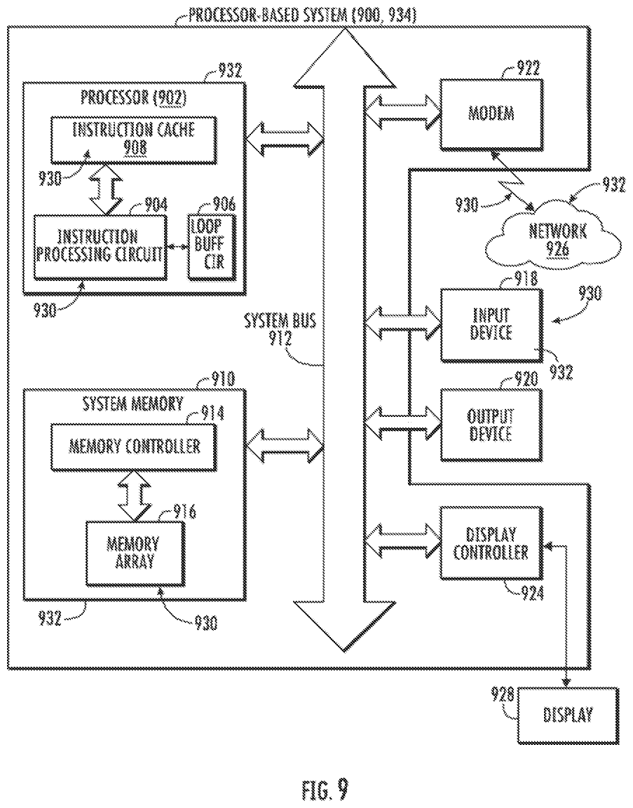

FIG. 9 is a block diagram of an exemplary processor-based system 900 that includes a processor 902 (e.g., a microprocessor) that includes an instruction processing circuit 904 for processing and executing instructions. The processor 902 and/or the instruction processing circuit 904 can include a loop buffer circuit 906 that can be configured to predict the number of iterations that a detected loop in an instruction stream fetched from a program code will be executed before the loop is exited, to reduce or avoid under- or over-iterating loop replay. The loop buffer circuit 906 can also be configured to predict the loop exit branch of the detected loop to predict the exact number of full iterations of the loop to replay and what instructions to replay for the last partial iteration of the loop, to further reduce or avoid under- or over-iterating loop replay. The loop buffer circuit 906 can also be configured to predict the exit target address of the loop to provide the starting address for fetching new instructions following loop exit for resuming fetching of new instructions following the loop exit. For example, the processor 902 in FIG. 9 could be the processor 200 in FIG. 2 that includes the instruction processing circuit 204 and the loop buffer circuit 220. The loop buffer circuit 906 can be the loop buffer circuit 220 in FIGS. 2 and 4.

The processor-based system 900 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server, or a user's computer. In this example, the processor-based system 900 includes the processor 902. The processor 902 represents one or more processing circuits, such as a microprocessor, central processing unit, or the like. The processor 902 is configured to execute processing logic in instructions for performing the operations and steps discussed herein. Fetched or prefetched instructions from a memory, such as from a system memory 910 over a system bus 912, are stored in an instruction cache 908. The instruction processing circuit 904 is configured to process instructions fetched into the instruction cache 908 and process the instructions for execution. These instructions fetched from the instruction cache 908 to be processed can include loops that are detected by the loop buffer circuit 906 for replay based on prediction of one or more loop characteristics as loop characteristic predictions.

The processor 902 and the system memory 910 are coupled to the system bus 912 and can intercouple peripheral devices included in the processor-based system 900. As is well known, the processor 902 communicates with these other devices by exchanging address, control, and data information over the system bus 912. For example, the processor 902 can communicate bus transaction requests to a memory controller 914 in the system memory 910 as an example of a slave device. Although not illustrated in FIG. 9, multiple system buses 912 could be provided, wherein each system bus constitutes a different fabric. In this example, the memory controller 914 is configured to provide memory access requests to a memory array 916 in the system memory 910. The memory array 916 is comprised of an array of storage bit cells for storing data. The system memory 910 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 912. As illustrated in FIG. 9, these devices can include the system memory 910, one or more input device(s) 918, one or more output device(s) 920, a modem 922, and one or more display controllers 924, as examples. The input device(s) 918 can include any type of input device, including, but not limited to, input keys, switches, voice processors, etc. The output device(s) 920 can include any type of output device, including, but not limited to, audio, video, other visual indicators, etc. The modem 922 can be any device configured to allow exchange of data to and from a network 926. The network 926 can be any type of network, including, but not limited to, a wired or wireless network, a private or public network, a local area network (LAN), a wireless local area network (WLAN), a wide area network (WAN), a BLUETOOTH™ network, and the Internet. The modem 922 can be configured to support any type of communications protocol desired. The processor 902 may also be configured to access the display controller(s) 924 over the system bus 912 to control information sent to one or more displays 928. The display(s) 928 can include any type of display, including, but not limited to, a cathode ray tube (CRT), a liquid crystal display (LCD), a plasma display, etc.

The processor-based system 900 in FIG. 9 may include a set of instructions 930 to be executed by the instruction processing circuit 904 of the processor 902 for any application desired according to the instructions 930. The instructions 930 may include loops as processed by the instruction processing circuit 904. The instructions 930 may be stored in the system memory 910, processor 902, and/or instruction cache 908 as examples of a non-transitory computer-readable medium 932. The instructions 930 may also reside, completely or at least partially, within the system memory 910 and/or within the processor 902 during their execution. The instructions 930 may further be transmitted or received over the network 926 via the modem 922, such that the network 926 includes the non-transitory computer-readable medium 932.

While the non-transitory computer-readable medium 932 is shown in an exemplary embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be referenced throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

1. A processor, comprising:
a hardware instruction processing circuit, comprising a loop buffer circuit configured to:
detect a loop among a plurality of instructions in an instruction stream in an instruction pipeline to be executed as a detected loop; and
in response to the detection of the detected loop in the instruction stream:
predict a number of full iterations of the detected loop to be executed in the instruction pipeline as a loop iteration prediction;
predict a loop exit branch of an instruction of the detected loop that will result in the detected loop being exited in the instruction pipeline as a loop exit branch prediction;
fully replay the detected loop in the instruction pipeline for the number of full iterations indicated by the loop iteration prediction; and
in response to a last full iteration of the detected loop being fully replayed in the instruction pipeline:
partially replay a plurality of instructions in the detected loop to the instruction at the loop exit branch indicated by the loop exit branch prediction.

2. The processor of claim 1, wherein the loop buffer circuit is configured to predict the number of full iterations of the detected loop as the loop iteration prediction, based on loop context information associated with at least one previous detected loop replayed in the instruction pipeline.

3. The processor of claim 1, wherein the loop buffer circuit is configured to predict the number of full iterations of the detected loop as the loop iteration prediction, based on loop context information associated with at least one previous replay of the detected loop in the instruction pipeline.

4. The processor of claim 2, wherein the loop buffer circuit is configured to generate the loop context information based on a program counter (PC) of at least one instruction in the detected loop and at least one PC of the at least one previous detected loop replayed in the instruction pipeline.

5. The processor of claim 2, further comprising:
a loop history register configured to store a loop history indicator; and
a loop context prediction circuit comprising a plurality of prediction entries each configured to store a loop iteration prediction;
the loop buffer circuit configured to predict the number of full iterations of the detected loop as the loop iteration prediction, by being configured to:
edit the loop history register based on loop context information for the at least one previous detected loop;
edit the loop history register based on the loop context information for the detected loop;
index the loop context prediction circuit based on the loop history register, to access a prediction entry among the plurality of prediction entries in the loop context prediction circuit; and
set the loop iteration prediction from the accessed prediction entry in the loop context prediction circuit.

6. The processor of claim 1, wherein the loop buffer circuit is configured to predict the loop exit branch of the detected loop as the loop exit branch prediction, based on loop path context information associated with at least one previous detected loop replayed in the instruction pipeline.

7. The processor of claim 1, wherein the loop buffer circuit is configured to predict the loop exit branch of the detected loop as the loop exit branch prediction, based on loop path context information associated with at least one previous replay of the detected loop in the instruction pipeline.

8. The processor of claim 6, wherein the loop buffer circuit is configured to generate the loop path context information based on a loop path history in the detected loop and a loop path history of the at least one previous detected loop replayed in the instruction pipeline.

9. The processor of claim 6, further comprising:
a loop path history register configured to store a loop path history indicator; and
a loop path context prediction circuit comprising a plurality of prediction entries each configured to store a loop exit branch prediction;
the loop buffer circuit configured to predict the loop exit branch of the detected loop as the loop exit branch prediction, by being configured to:
edit the loop path history register based on the loop path context information for the at least one previous detected loop;
edit the loop path history register based on loop path context information for the detected loop;
index the loop path context prediction circuit based on the loop path history register, to access a prediction entry among the plurality of prediction entries in the loop path context prediction circuit; and
set the loop exit branch prediction from the accessed prediction entry in the loop path context prediction circuit.

10. The processor of claim 6, wherein the loop path context information comprises loop exit branch context information indicating a loop exit branch of the at least one previous detected loop.

11. The processor of claim 6, wherein the loop path context information comprises loop exit branch position context information indicating a loop exit branch position of the at least one previous detected loop.

12. The processor of claim 1, wherein the hardware instruction processing circuit further comprises:
an instruction fetch circuit configured to fetch the plurality of instructions into the instruction pipeline as the instruction stream to be executed; and
an execution circuit configured to execute the plurality of instructions in the instruction stream.

13. The processor of claim 12, wherein the loop buffer circuit is further configured to:
in response to replay of the detected loop in the instruction pipeline:
instruct the instruction fetch circuit to halt fetching next instructions into the instruction pipeline; and
predict an exit target address of a next instruction to be executed following exit of the detected loop in the instruction pipeline as a loop exit target prediction; and
instruct the instruction fetch circuit to start fetching next instructions into the instruction pipeline starting at the exit target address of the loop exit target prediction.

14. The processor of claim 13, wherein:
the loop buffer circuit is further configured to detect the exit of the replay of the detected loop in the instruction pipeline; and
the hardware instruction processing circuit is further configured to:
hold the next fetched instructions in the instruction pipeline from execution in the execution circuit in response to the replay of the detected loop; and
release the next fetched instructions in the instruction pipeline to be executed in the execution circuit in response to the detected exit of the replay of the detected loop.

15. The processor of claim 13, wherein the hardware instruction processing circuit further comprises a decode circuit configured to decode the fetched plurality of instructions into a plurality of decoded instructions;
the execution circuit is configured to execute the plurality of decoded instructions in the instruction stream; and
the hardware instruction processing circuit is configured to:
hold the next fetched instructions in the decode circuit of the instruction pipeline from execution in the execution circuit in response to the replay of the detected loop; and
release the next fetched instructions from the decode circuit in the instruction pipeline to be executed in the execution circuit in response to a detected exit of the replay of the detected loop.

16. The processor of claim 13, wherein the loop buffer circuit is configured to instruct the instruction fetch circuit to start fetching the next instructions into the instruction pipeline starting at the exit target address of the loop exit target prediction, in response to the detection of the detected loop in the instruction pipeline.

17. The processor of claim 13, wherein:
the loop buffer circuit is further configured to detect when the exit of the replay of the detected loop will occur by an exit lead time; and
the loop buffer circuit is configured to instruct the instruction fetch circuit to start fetching the next instructions into the instruction pipeline starting at the exit target address of the loop exit target prediction, in response to detecting the exit of the replay of the detected loop will occur by the exit lead time.

18. The processor of claim 13, wherein the loop buffer circuit is further configured to:
determine if the loop iteration prediction and the loop exit branch prediction are each associated with a respective high confidence indicator exceeding a respective defined confidence indicator threshold; and
in response to determining the loop iteration prediction and the loop exit branch prediction are associated with respective high confidence indicator indicators, cause the next fetched instructions to be released in the instruction pipeline to the execution circuit to be executed.

19. The processor of claim 13, wherein the loop buffer circuit is configured to predict the exit target address as the loop exit target prediction, based on loop exit target context information associated with an exit of at least one previous detected loop replayed in the instruction pipeline.

20. The processor of claim 13, wherein the loop buffer circuit is configured to predict the exit target address as the loop exit target prediction, based on loop exit target context information associated with an exit of at least one previous replay of the detected loop in the instruction pipeline.

21. The processor of claim 19, further comprising:
a loop exit target history register configured to store a loop history indicator; and
a loop exit target context prediction circuit comprising a plurality of prediction entries each configured to store a loop exit target prediction;
the loop buffer circuit configured to predict the exit target address as the loop exit target prediction, by being configured to:
edit the loop exit target history register based on loop exit target context information for the exit of the at least one previous detected loop;
edit the loop exit target history register based on the loop exit target context information for the detected loop;
index the loop exit target context prediction circuit based on the loop exit target history register, to access a prediction entry among the plurality of prediction entries in the loop exit target context prediction circuit; and
set the loop exit target prediction from the accessed prediction entry in the loop exit target context prediction circuit.

22. The processor of claim 13, wherein the loop buffer circuit is further configured to:
determine if the loop iteration prediction is associated with a low confidence indicator not exceeding a defined confidence indicator threshold; and
in response to determining the loop iteration prediction is associated with a low confidence indicator:
(a) replay the detected loop in the instruction pipeline;
(b) determine whether the replay of the detected loop in the instruction pipeline exits;
in response to determining that the replay of the detected loop in the instruction pipeline does not exit, repeat (a)-(b); and
in response to determining that the replay of the detected loop in the instruction pipeline exits, not replay the detected loop in the instruction pipeline.

23. A method of replaying a loop in an instruction pipeline in a processor, comprising:
detecting the loop among a plurality of instructions in an instruction stream in the instruction pipeline to be executed as a detected loop; and
in response to the detection of the detected loop in the instruction stream:
predicting a number of full iterations of the detected loop to be executed in the instruction pipeline as a loop iteration prediction;
predicting a loop exit branch of an instruction of the detected loop that will result in the detected loop being exited in the instruction pipeline as a loop exit branch prediction;
fully replaying the detected loop in the instruction pipeline for the number of full iterations indicated by the loop iteration prediction; and
partially replaying a plurality of instructions in the detected loop to the instruction at the loop exit branch indicated by the loop exit branch prediction, in response to a last full iteration of the detected loop being fully replayed in the instruction pipeline.

24. A processor, comprising:
a hardware instruction processing circuit, comprising:
an instruction fetch circuit configured to fetch a plurality of instructions into an instruction pipeline as an instruction stream to be executed; and
an execution circuit configured to execute the plurality of instructions in the instruction stream; and
a loop buffer circuit configured to:
detect a loop among the plurality of instructions in the instruction stream in the instruction pipeline to be executed in the execution circuit as a detected loop;
replay the detected loop in the instruction pipeline; and
in response to the replay of the detected loop in the instruction pipeline:
instruct the instruction fetch circuit to halt fetching next instructions into the instruction pipeline; and
predict an exit target address of a next instruction to be executed following exit of the detected loop in the instruction pipeline as a loop exit target prediction; and
instruct the instruction fetch circuit to start fetching next instructions into the instruction pipeline starting at the exit target address of the loop exit target prediction.

25. The processor of claim 24, wherein:
the loop buffer circuit is further configured to detect the exit of the replay of the detected loop in the instruction pipeline; and
the hardware instruction processing circuit is further configured to:
hold the next fetched instructions in the instruction pipeline from execution in the execution circuit in response to the replay of the detected loop; and
release the next fetched instructions in the instruction pipeline to be executed in the execution circuit in response to the detected exit of the replay of the detected loop.

26. The processor of claim 25, wherein the hardware instruction processing circuit further comprises a decode circuit configured to decode the fetched plurality of instructions into a plurality of decoded instructions;
the execution circuit is configured to execute the plurality of decoded instructions in the instruction stream; and
the hardware instruction processing circuit is configured to:
hold the next fetched instructions in the decode circuit of the instruction pipeline from execution in the execution circuit in response to the replay of the detected loop; and
release the next fetched instructions from the decode circuit in the instruction pipeline to be executed in the execution circuit in response to the detected exit of the replay of the detected loop.

27. The processor of claim 24, wherein the loop buffer circuit is configured to instruct the instruction fetch circuit to start fetching the next instructions into the instruction pipeline starting at the exit target address of the loop exit target prediction, in response to the detection of the detected loop in the instruction pipeline.

28. The processor of claim 24, wherein:
the loop buffer circuit is further configured to detect when the exit of the replay of the detected loop will occur by an exit lead time; and
the loop buffer circuit is configured to instruct the instruction fetch circuit to start fetching the next instructions into the instruction pipeline starting at the exit target address of the loop exit target prediction, in response to detecting the exit of the replay of the detected loop will occur by the exit lead time.

29. The processor of claim 24, wherein the loop buffer circuit is further configured to detect the exit of the replay of the detected loop in the instruction pipeline; and
the loop buffer circuit is configured to instruct the instruction fetch circuit to start fetching the next instructions into the instruction pipeline starting at the exit target address of the loop exit target prediction, in response to the exit of the detected loop in the instruction pipeline.

30. The processor of claim 24, wherein the loop buffer circuit is configured to predict the exit target address as the loop exit target prediction, based on loop exit target context information associated with an exit of at least one previous detected loop replayed in the instruction pipeline.

31. The processor of claim 24, wherein the loop buffer circuit is configured to predict the exit target address as the loop exit target prediction, based on loop exit target context information associated with an exit of at least one previous replay of the detected loop in the instruction pipeline.

32. The processor of claim 30, further comprising:
a loop exit target history register configured to store a loop history indicator; and
a loop exit target context prediction circuit comprising a plurality of prediction entries each configured to store a loop exit target prediction;
the loop buffer circuit configured to predict the exit target address as the loop exit target prediction, by being configured to:
edit the loop exit target history register based on the loop exit target context information for the exit of the at least one previous detected loop;
edit the loop exit target history register based on loop exit target context information for the detected loop;
index the loop exit target context prediction circuit based on the loop exit target history register, to access a prediction entry among the plurality of prediction entries in the loop exit target context prediction circuit; and
set the loop exit target prediction from the accessed prediction entry in the loop exit target context prediction circuit.

33. A method of fetching next instructions following a detected loop replayed in an instruction pipeline in a processor, comprising:
fetching a plurality of instructions into the instruction pipeline as an instruction stream to be executed;
detecting a loop among the plurality of instructions in the instruction stream in the instruction pipeline to be executed as a detected loop;
replaying the detected loop in the instruction pipeline;
in response to the replaying of the detected loop in the instruction pipeline:
instructing an instruction fetch circuit to halt fetching next instructions into the instruction pipeline; and
predicting an exit target address of a next instruction to be executed following exit of the detected loop in the instruction pipeline as a loop exit target prediction; and
instructing the instruction fetch circuit to start fetching next instructions into the instruction pipeline starting at the exit target address of the loop exit target prediction.
